(19) United States
(12) Patent Application Publication
(10) Pub. No.: US 2010/0214219 A1
(43) Pub. Date: Aug. 26, 2010

(54) TILT WHEEL MOUSE

(75) Inventor: Yu-Chih Cheng, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/409,852

(22) Filed: Mar. 24, 2009

(30) Foreign Application Priority Data
Feb. 20, 2009 (TW) 098105392

(51) Int. Cl. G09G 5/08

(52) U.S. Cl. 345/163

(57) ABSTRACT

A tilt wheel mouse includes a scroll wheel, a wheel swing member, a base, a circuit board, a first elastic element, a second elastic element, an encoder, a first tilt switch, a second tilt switch, and a wheel switch. The first tilt switch and the second tilt switch are arranged at the backside of the wheel swing member. The wheel switch is arranged under the wheel swing member. Since the distance between the wheel switch and the first or second tilt switch is increased, the possibility of causing an erroneous operation is minimized.

### FIELD OF THE INVENTION

The present invention relates to a mouse, and more particularly to a tilt wheel mouse.

### BACKGROUND OF THE INVENTION

With rapid development of electronic and information industries, computers and the peripheral device thereof become essential parts in our daily lives. For example, mice are important peripheral devices of computers because they can establish contact between the personal computers and the users. For helping the user well operate the computer, many novel mice with expanded functions are developed in views of humanization and user-friendliness.

For example, by rotating a scroll wheel of the mouse device forwardly or backwardly, a specified control signal is generated to control the scrolling operations of web pages. In addition to the vertical scroll movement, it is important to achieve the horizontal scroll movement. Since the texts or graphs shown in the graphic-based window of the display screen usually fail to be fully browsed, the horizontal scroll movement is required to move the web page or document in the left or right direction so as to display the desired image. Since the scroll wheel assembly of a conventional mouse device permits for single axial rotation, the image shown on the screen of the computer system may be vertically scrolled. For horizontally moving the web page or document shown on the screen by operating the scroll wheel, the left click button of the mouse device should be continuously pressed down and tilted in the horizontal direction. Since the single axial rotation of the mouse device is unsatisfactory for horizontal scroll movement, a tilt wheel mouse is developed for controlling horizontal scroll movement of the image shown on the computer screen.

Except for the inner portion, the outward appearance of the conventional tilt wheel mouse is similar to that of the typical wheel mouse. For clarification and brevity, only the inner portion of the conventional tilt wheel mouse is illustrated. FIG. 1 is a schematic perspective view illustrating the inner portion of a conventional tilt wheel mouse. The inner portion of the tilt wheel mouse 1 principally comprises a scroll wheel 11, a wheel swing member 12, a first supporting element 13 with a first notch 131, a second supporting element 14 with a second notch 141, a first switch 15, a second switch 16 and a third switch 17. The first switch 15, the second switch 16 and the third switch 17 are disposed under the wheel swing member 12 and respectively arranged at bilateral sides and a backside of the wheel swing member 12. In addition, other components (e.g. a base, an encoder and a circuit board) of the tilt wheel mouse 1 are known in the art, and are not redundantly described herein. As shown in FIG. 1, the scroll wheel 11 has a rotating shaft 111. The scroll wheel 11 is accommodated within the wheel swing member 12. The scroll wheel 11 includes a first extension arm 121, a second extension arm 122, a swing member notch 123, a first swing member axle 124 and a second swing member axle 125. The rotating shaft 111 is partially received in the swing member notch 123. The first extension arm 121 is disposed at a first side of the scroll wheel 11 and above the first switch 15. When the scroll wheel 11 is tilted toward the left side, the scroll wheel 11 will touch the first switch 15 so as to trigger the first switch 15. The second extension arm 122 is disposed at a second side of the scroll wheel 11 and above the second switch 16. Similarly, when scroll wheel 11 is tilted toward the right side, the scroll wheel 11 will touch the second switch 16 so as to trigger the second switch 16. The first swing member axle 124 is partially received in the first notch 131 of the first supporting element 13. The second swing member axle 125 is partially received in the second notch 141 of the second supporting element 14. As such, the wheel swing member 12 can be swung toward the left or right side.

As the scroll wheel 11 is tilted toward the left side, the wheel swing member 12 is swing toward the left side such that the first switch 15 is touched by first extension arm 121 to generate a left-side tilt signal. In response to the left-side tilt signal, the web page or document shown on the screen is horizontally scrolled in the left direction. Whereas, as the scroll wheel 11 is tilted toward the right side, the wheel swing member 12 is swing toward the right side such that the second switch 16 is touched by second extension arm 122 to generate a right-side tilt signal. In response to the right-side tilt signal, the web page or document shown on the screen is horizontally scrolled in the right direction. When the scroll wheel 11 is pressed down, the scroll wheel 11 and the wheel swing member 12 are moved downwardly such that the third switch 17 is touched by the second swing member axle 125 to execute a wheel button function.

Although the conventional tilt wheel mouse has both of the vertical and horizontal scrolling functions, there are still some drawbacks. For example, for executing the wheel button function, a depressing force needs to be exerted on the scroll wheel 11 to have the second swing member axle 125 of the wheel swing member 12 touch the third switch 17. Since the depressing force applied onto the scroll wheel 11 is likely to improperly swing toward the left or right side, the first switch 15 or the second switch 16 is possibly triggered by the first extension arm 121 or the second extension arm 122 of the wheel swing member 12. Since two switches are simultaneously triggered, the computer fails to realize the instruction issued by the tilt wheel mouse 1. Under this circumstance, the tilt wheel mouse 1 is suffered from an erroneous operation.

### SUMMARY OF THE INVENTION

It is an object of the present invention to provide a tilt wheel mouse for avoiding erroneous operation.

In accordance with an aspect of the present invention, there is provided a tilt wheel mouse. The tilt wheel mouse includes a base, a circuit board, a scroll wheel, a first tilt switch, a second tilt switch, a first elastic element, a second elastic element, and a wheel swing member. The base has a first supporting element and a second supporting element. The circuit board is disposed on the base. The first tilt switch is disposed on the circuit board and arranged at a first side of the scroll wheel. The second tilt switch is disposed on the circuit board and arranged at a second side of the scroll wheel. The first elastic element is arranged at the first side of the scroll wheel. The second elastic element is arranged at the second side of the scroll wheel. The wheel swing member is disposed on the base for accommodating the scroll wheel and permitted to be swung in a first direction or a second direction. The wheel swing member has a first end connected to the first supporting element and a second end connected to the second supporting element. The wheel swing member includes a triggering rod, a first extension arm and a second extension arm. The triggering rod is protruded from the second end of the wheel swing member. The first terminal of the triggering rod is disposed above the first tilt switch. The second terminal of the triggering rod is disposed above the second tilt switch. The first extension arm is arranged at a first side of the wheel swing member and connected with the first elastic element. The second extension arm is arranged at a second side of the wheel swing member and connected with the second elastic element. When the scroll wheel is tilted in the first direction, the wheel swing member is swung in the first direction such that the first tilt switch is touched and triggered by the first terminal of the triggering rod. When the scroll wheel is tilted in the second direction, the wheel swing member is swung in the second direction such that the second tilt switch is touched and triggered by the second terminal of the triggering rod.

In an embodiment, the tilt wheel mouse further includes an encoder. The encoder generates a wheel rotation signal when the scroll wheel is rotated.

In an embodiment, the scroll wheel further includes a rotating shaft inserted into the encoder and rotated with the scroll wheel, so that the encoder generates the wheel rotation signal when the scroll wheel is rotated.

In an embodiment, the wheel swing member further includes a receiving part disposed at the first side of the wheel swing member for accommodating the encoder.

In an embodiment, the tilt wheel mouse further includes an encoder cover for sheltering the encoder such that the encoder is not exposed.

In an embodiment, the first extension arm and the second extension arm are integrally formed with the wheel swing member.

In an embodiment, the first elastic element and the second elastic element are helical springs.

In an embodiment, the triggering rod is integrally formed with the wheel swing member.

In an embodiment, the first supporting element has a perforation, the second supporting element has a notch, the first end of the wheel swing member is penetrated through the perforation of the first supporting element, and the second end of the wheel swing member is partially received in the notch of the second supporting element.

In an embodiment, the wheel swing member further includes a swing member triggering part formed on a middle and bottom surface of the wheel swing member.

In an embodiment, the tilt wheel mouse further includes a wheel switch disposed on the base and under the wheel swing member. When the scroll wheel is pressed down, the first elastic element and the second elastic element are compressed, and the wheel swing member is moved downwardly toward the base, so that the wheel switch is touched and triggered by the swing member triggering part to issue a wheel button signal to the circuit board.

In an embodiment, the wheel swing member further includes a conducting wire. The conducting wire has a terminal connected to the wheel switch and the other terminal connected to the circuit board, so that the wheel button signal is transmitted from the wheel switch to the circuit board through the conducting wire.

In an embodiment, the triggering rod is arc-shaped.

In an embodiment, the second supporting element is integrally formed with the base.

In an embodiment, the circuit board further includes a fixing hole. The second supporting element is penetrated through the fixing hole such that the second end of the wheel swing member is connected to the second supporting element.

In an embodiment, the tilt wheel mouse further includes a case for sheltering the base. The case has an opening. The scroll wheel is partially protruded outside the case.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the inner portion of a conventional tilt wheel mouse;

FIG. 2 is a schematic perspective view illustrating the outward appearance of a tilt wheel mouse according to a preferred embodiment of the present invention;

FIG. 3 is a schematic perspective view illustrating the inner portion of the tilt wheel mouse according to a preferred embodiment of the present invention;

FIG. 4 is a schematic perspective view illustrating the inner portion of the tilt wheel mouse of FIG. 3 taken from a different viewpoint; and

FIG. 5 is a schematic cutaway view illustrating the tilt wheel mouse according to a preferred embodiment of the present invention.

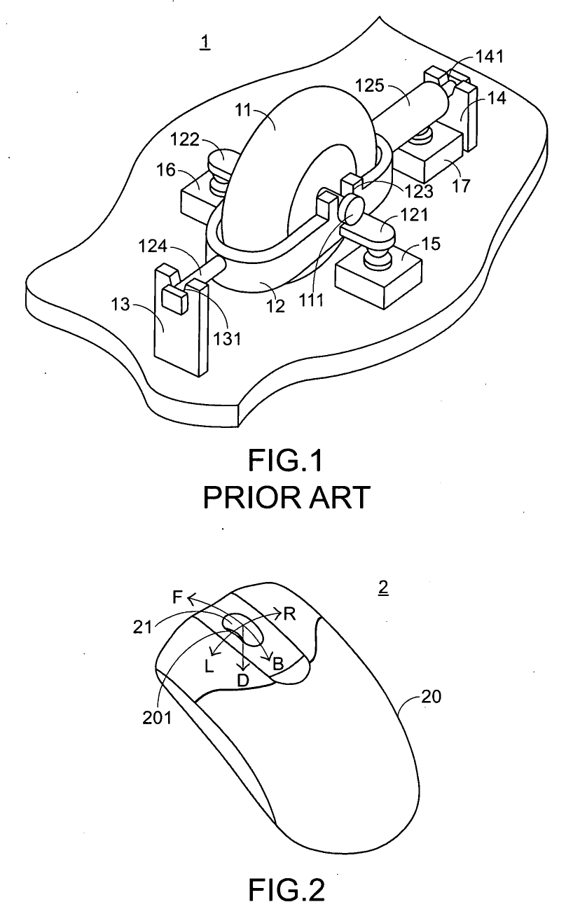

### DETAILED DESCRIPTION OF THE PREFERRED EMBODIMENT

FIG. 2 is a schematic perspective view illustrating the outward appearance of a tilt wheel mouse according to a preferred embodiment of the present invention. As shown in FIG. 2, the tilt wheel mouse 2 comprises a case 20 and a scroll wheel 21. The scroll wheel 21 is positioned within an opening 201 of the case 20 and partially protruded from the outer surface of the case 20, so that the scroll wheel 21 can be manipulated by a user. By rotating the scroll wheel 21 forwardly (in the direction F) or backwardly (in the direction B), the image shown on the computer screen is vertically scrolled. By tilting the scroll wheel 21 toward the right side (in the direction R) or the left side (in the direction L), the image shown on the computer screen is horizontally scrolled. In addition, when the scroll wheel 21 is pressed down (in the direction D), the tilt wheel mouse 2 executes the wheel button function.

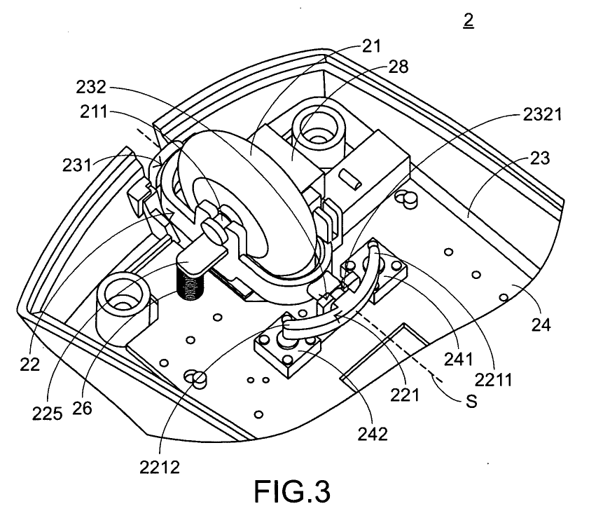

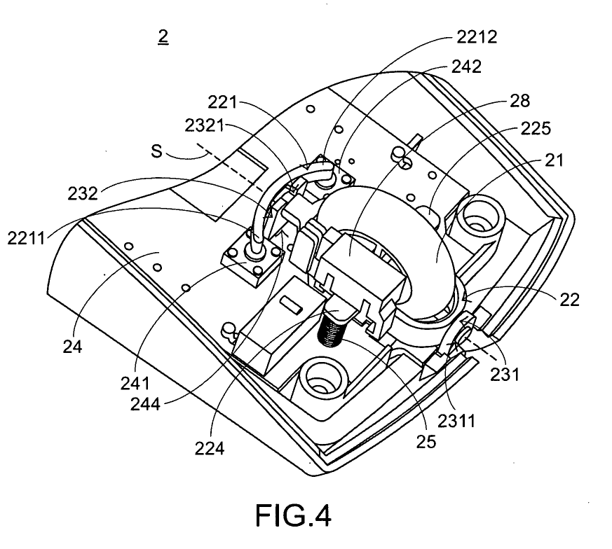

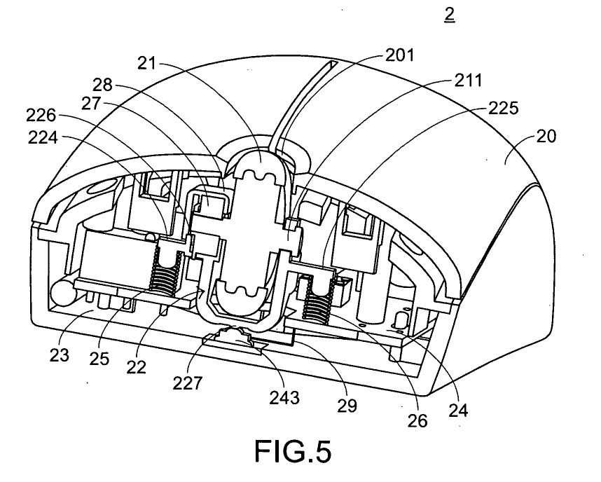

FIG. 3 is a schematic perspective view illustrating the inner portion of the tilt wheel mouse according to a preferred embodiment of the present invention. FIG. 4 is a schematic perspective view illustrating the inner portion of the tilt wheel mouse of FIG. 3 taken from a different viewpoint. As shown in FIGS. 3 and 4, the inner portion of the tilt wheel mouse 2 principally comprises a scroll wheel 21, a wheel swing member 22, a base 23, a circuit board 24, a first elastic element 25, a second elastic element 26, an encoder 27 (as shown in FIG. 5), a first tilt switch 241 and a second tilt switch 242. The base 23 has a first supporting element 231 and a second supporting element 232. The first supporting element 231 has a perforation 2311. The second supporting element 232 has a notch 2321. It is preferred that the second supporting element 232 is integrally formed with the base 23. The first supporting element 231 is fixed on the base 23 by screwing means.

As shown in FIG. 4, the wheel swing member 22 is disposed on the base 23. A first end of the wheel swing member 22 is connected to the first supporting element 231. A second end of the wheel swing member 22 is connected to the second supporting element 232. The first end and the second end of the wheel swing member 22 are arranged along an axial line S. The first end of the wheel swing member 22 is penetrated through the perforation 2311 of the first supporting element 231 such that the first end of the wheel swing member 22 is connected to the first supporting element 231. The second end of the wheel swing member 22 is partially received in the notch 2321 of the second supporting element 232 such that the second end of the wheel swing member 22 is connected to the second supporting element 232. In such manner, the wheel swing member 22 can be swung with respect to the base 23 by using the first end and the second end of the wheel swing member 22 (i.e. along an axial line S) as a shaft. Please refer to FIGS. 3 and 4 again. The wheel swing member 22 includes a triggering rod 221, a first extension arm 224, a second extension arm 225, a receiving part 226 (as shown in FIG. 5) and a swing member triggering part 227 (as shown in FIG. 5).

FIG. 5 is a schematic cutaway view illustrating the tilt wheel mouse according to a preferred embodiment of the present invention. The scroll wheel 21 is accommodated within the wheel swing member 22. The receiving part 226 is disposed at the first side of the wheel swing member 22 for accommodating the encoder 27. The scroll wheel 21 has a rotating shaft 211 inserted into the encoder 27. Upon rotation of the scroll wheel 21, the encoder 27 generates a wheel rotation signal. The tilt wheel mouse 2 further includes an encoder cover 28 for sheltering the encoder 27 such that the encoder 27 is not exposed. The swing member triggering part 227 is formed on a middle and bottom surface of the wheel swing member 22. The tilt wheel mouse 2 further includes a wheel switch 243. The wheel switch 243 is mounted on the base 23 and disposed under the swing member triggering part 227 of the wheel swing member 22. Via a conducting wire 29, the wheel switch 243 is electrically connected to the circuit board 24.

Please refer to FIGS. 3 and 4 again. The circuit board 24 is disposed on the base 23. The circuit board 24 further includes a fixing hole 244. The second supporting element 232 is penetrated through the fixing hole 244 such that the second end of the wheel swing member 22 is connected to the second supporting element 232. The first tilt switch 241 is mounted on the circuit board 24 and disposed at a first side of the scroll wheel 21. The second tilt switch 242 is mounted on the circuit board 24 and disposed at a second side of the scroll wheel 21. The first elastic element 25 is disposed at the first side of the scroll wheel 21. The second elastic element 26 is disposed at the second side of the scroll wheel 21. Examples of the first elastic element 25 and the second elastic element 26 are helical springs.

The triggering rod 221 of the wheel swing member 22 is protruded from the second end of the wheel swing member 22. It is preferred that the triggering rod 221 is integrally formed with the wheel swing member 22. As the wheel swing member 22 is swung, the triggering rod 221 is synchronously swung. A first terminal 2211 of the triggering rod 221 is disposed above the first tilt switch 241. A second terminal 2212 of the triggering rod 221 is disposed above the second tilt switch 242. In an embodiment, the triggering rod 221 is arc-shaped. The triggering rod 221 is not restricted to the arc shape. That is, the triggering rod 221 may have an arbitrary shape.

The first extension arm 224 is extended from the first side of the wheel swing member 22. The second extension arm 225 is extended from the second side of the wheel swing member 22. In other words, the first extension arm 224 and the second extension arm 225 are integrally formed with the wheel swing member 22. The first extension arm 224 is connected with the first elastic element 25. The second extension arm 225 is connected with the second elastic element 26. In a case that the scroll wheel 21 is not tilted, the first elastic element 25 and the second elastic element 26 are separated from the circuit board 24 by a gap. Under this circumstance, the first elastic element 25 and the second elastic element 26 are in the normal state or uncompressed state.

The operations of the tilt wheel mouse 2 will be illustrated in more details as follows.

In a case that the scroll wheel 21 is rotated forwardly (in the direction F) or backwardly (in the direction B), the rotating shaft 211 is driven to rotate and thus the encoder 27 generates a corresponding wheel rotation signal. In response to the wheel rotation signal, a vertical scrolling function of the wheel mouse 2 is executed, and thus the graphic-based window or the web page shown on the computer screen is scrolled in the vertical direction (see FIG. 2 and FIG. 5).

In a case that the scroll wheel 21 is tilted toward the right side (in the direction R), the wheel swing member 22 is swung toward the right side by using the first end and the second end of the wheel swing member 22 as the shaft. That is, the wheel swing member 22 is rotated about the axial line S. As the wheel swing member 22 is swung toward the right side, the first extension arm 224 is synchronously swung toward the right side. At the same time, the first extension arm 224 is sustained against the first elastic element 25 such that the first elastic element 25 is contacted with the circuit board 24 and the first elastic element 25 is in a compressed state. In addition, as the wheel swing member 22 is swung toward the right side, the triggering rod 221 at the second end of the wheel swing member 22 is synchronously swung toward the right side. As such, the first tilt switch 241 is touched by the first terminal 2211 of the triggering rod 221, thereby issuing a first tilt signal to the circuit board 24. In response to the first tilt signal, the graphic-based window or the web page shown on the computer screen is horizontally scrolled in the right side direction. Until the external force for tilting the scroll wheel 21 toward the right side is eliminated, the compressed first elastic element 25 will be restored such that the wheel swing member 22 is returned to its original position (as shown in FIG. 2 and FIG. 4).

In a case that the scroll wheel 21 is tilted toward the left side (in the direction L), the wheel swing member 22 is swung toward the left side by using the first end and the second end of the wheel swing member 22 as the shaft. As the wheel swing member 22 is swung toward the left side, the second extension arm 225 is synchronously swung toward the left side. At the same time, the second extension arm 225 is sustained against the second elastic element 26 such that the second elastic element 26 is contacted with the circuit board 24 and the second elastic element 26 is in a compressed state. In addition, as the wheel swing member 22 is swung toward the left side, the triggering rod 221 at the second end of the wheel swing member 22 is synchronously swung toward the left side. As such, the second tilt switch 242 is touched by the second terminal 2212 of the triggering rod 221, thereby issuing a second tilt signal to the circuit board 24. In response to the second tilt signal, the graphic-based window or the web page shown on the computer screen is horizontally scrolled in the left side direction. Until the external force for tilting the scroll wheel 21 toward the left side is eliminated, the compressed second elastic element 26 will be restored such that the wheel swing member 22 is returned to its original position (as shown in FIG. 2 and FIG. 3).

In a case that the scroll wheel 21 is pressed down (in the direction D), the depressing force will move the wheel swing member 22 downwardly. As the wheel swing member 22 is moved downwardly, the first extension arm 224 and the second extension arm 225 at bilateral sides of the wheel swing member 22 are synchronously moved downwardly. At the same time, the first extension arm 224 and the second extension arm 225 are respectively sustained against the first elastic element 25 and the second elastic element 26. As such, the first extension arm 224 and the second extension arm 225 are in the compressed state. In addition, as the wheel swing member 22 is moved downwardly toward the base 23, the wheel switch 243 is touched by the swing member triggering part 227 of the wheel swing member 22, thereby issuing a switch button signal to the circuit board 24 and enabling the wheel button function of the tilt wheel mouse 2 (see FIG. 2 and FIG. 5).

From the above description, the first tilt switch and the second tilt switch are arranged at the backside of the wheel swing member. In addition, the first elastic element and the second elastic element are arranged at the locations where the two tilt switches of the conventional tilt wheel mouse are originally arranged. Since the distance between the wheel switch (or the wheel swing member) and the first or second tilt switch (or the first or second terminal of the triggering rod) is increased, the possibility of causing an erroneous operation when the scroll wheel is pressed down is minimized. Similarly, the possibility of causing an erroneous operation when the scroll wheel is tilted toward the right or left side is also minimized. Since the first tilt switch and the second tilt switch are arranged at the backside of the wheel swing member and the first elastic element and the second elastic element are arranged at bilateral sides of the wheel swing member, the touch feel of operating the scroll wheel becomes humanized and more natural. Moreover, the uses of the first elastic element and the second elastic element can facilitate returning the scroll wheel to its original position. In comparison with the prior art, the tilt wheel mouse of the present invention is more advantageous.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A tilt wheel mouse comprising:
a base having a first supporting element and a second supporting element;
a circuit board disposed on said base;
a scroll wheel;
a first tilt switch disposed on said circuit board and arranged at a first side of said scroll wheel;
a second tilt switch disposed on said circuit board and arranged at a second side of said scroll wheel;
a first elastic element arranged at said first side of said scroll wheel;
a second elastic element arranged at said second side of said scroll wheel; and
a wheel swing member disposed on said base for accommodating said scroll wheel and permitted to be swung in a first direction or a second direction, said wheel swing member having a first end connected to said first supporting element and a second end connected to said second supporting element, said wheel swing member including a triggering rod, a first extension arm and a second extension arm, wherein said triggering rod is protruded from said second end of said wheel swing member, a first terminal of said triggering rod is disposed above said first tilt switch, a second terminal of said triggering rod is disposed above said second tilt switch, said first extension arm is arranged at a first side of said wheel swing member and connected with said first elastic element, and said second extension arm is arranged at a second side of said wheel swing member and connected with said second elastic element,
wherein when said scroll wheel is tilted in said first direction, said wheel swing member is swung in said first direction such that said first tilt switch is touched and triggered by said first terminal of said triggering rod, and when said scroll wheel is tilted in said second direction, said wheel swing member is swung in said second direction such that said second tilt switch is touched and triggered by said second terminal of said triggering rod.

2. The tilt wheel mouse according to claim 1 further including an encoder, wherein said encoder generates a wheel rotation signal when said scroll wheel is rotated.

3. The tilt wheel mouse according to claim 2 wherein said scroll wheel further includes a rotating shaft inserted into said encoder and rotated with said scroll wheel, so that said encoder generates said wheel rotation signal when said scroll wheel is rotated.

4. The tilt wheel mouse according to claim 2 wherein said wheel swing member further includes a receiving part disposed at said first side of said wheel swing member for accommodating said encoder.

5. The tilt wheel mouse according to claim 2 further including an encoder cover for sheltering said encoder such that said encoder is not exposed.

6. The tilt wheel mouse according to claim 1 wherein said first extension arm and said second extension arm are integrally formed with said wheel swing member.

7. The tilt wheel mouse according to claim 1 wherein said first elastic element and said second elastic element are helical springs.

8. The tilt wheel mouse according to claim 1 wherein said triggering rod is integrally formed with said wheel swing member.

9. The tilt wheel mouse according to claim 1 wherein said first supporting element has a perforation, said second supporting element has a notch, said first end of said wheel swing member is penetrated through said perforation of said first supporting element, and said second end of said wheel swing member is partially received in said notch of said second supporting element.

10. The tilt wheel mouse according to claim 1 wherein said wheel swing member further includes a swing member triggering part formed on a middle and bottom surface of said wheel swing member.

11. The tilt wheel mouse according to claim 10 further including a wheel switch disposed on said base and under said wheel swing member, wherein when said scroll wheel is pressed down, said first elastic element and said second elastic element are compressed, and said wheel swing member is moved downwardly toward said base, so that said wheel switch is touched and triggered by said swing member triggering part to issue a wheel button signal to said circuit board.

12. The tilt wheel mouse according to claim 11 further including a conducting wire, wherein said conducting wire has a terminal connected to said wheel switch and the other terminal connected to said circuit board, so that said wheel button signal is transmitted from said wheel switch to said circuit board through said conducting wire.

13. The tilt wheel mouse according to claim 1 wherein said triggering rod is arc-shaped.

14. The tilt wheel mouse according to claim 1 wherein said second supporting element is integrally formed with said base.

15. The tilt wheel mouse according to claim 1 wherein said circuit board further includes a fixing hole, and said second supporting element is penetrated through said fixing hole such that said second end of said wheel swing member is connected to said second supporting element.

16. The tilt wheel mouse according to claim 1 further including a case for sheltering said base, wherein said case has an opening, and said scroll wheel is partially protruded outside said case.
